(19) United States
(12) Patent Application Publication
(10) Pub. No.: US 2022/0095129 A1
(43) Pub. Date: Mar. 24, 2022

(54) ADAPTIVE COVERAGE OPTIMIZATION IN SINGLE-FREQUENCY NETWORKS (SFN)

(71) Applicant: Rohde & Schwarz GmbH & Co. KG, Munich (DE)

(72) Inventors: Johannes SINNHUBER, Munich (DE); Thomas JANNER, Groebenzell (DE)

(21) Appl. No.: 17/307,736

(22) Filed: May 4, 2021

(30) Foreign Application Priority Data
Sep. 24, 2020 (EP) 20 197 987.9

(51) Int. Cl. H04W 24/02; H04W 24/08

(52) U.S. Cl. CPC H04W 24/02; H04W 24/08

(57) ABSTRACT

A single-frequency network, SFN, system comprises: at least two independently controlled SFN transmitters; a network entity being arranged for computing optimized SFN transmission parameters specifically for each of the at least two SFN transmitters; and one or more field probes arranged in the SFN and connected to the network entity via a network communication channel. The one or more field probes are arranged for measuring, preferably continuously, an SFN reception of signals transmitted by the at least two independently controlled SFN transmitters, producing field measurement data, and supplying the field measurement data to the network entity. The network entity is arranged for automatically calculating, as a function of the supplied field measurement data, at least one type of SFN transmission parameter specifically optimized for each of the at least two independently controlled SFN transmitters, in order to optimize the SFN reception of the signals transmitted by the at least two independently controlled SFN transmitters, and supplying the transmitter-specifically optimized SFN transmission parameters to each of the at least two independently controlled SFN transmitters.

### PRIORITY

This application claims priority of European Patent Application EP 20 197 987.9 filed on Sep. 24, 2020, which is incorporated by reference herewith.

### FIELD OF THE INVENTION

The present application relates to single-frequency networks, and in particular to a method for adaptive optimization of reception/coverage within an SFN, as well as to a corresponding network entity and a corresponding SFN system.

### BACKGROUND OF THE INVENTION

In single-frequency networks, a plurality of transmitters simultaneously transmits/broadcasts a same signal over a same frequency channel. Areas of bad reception in an SFN are difficult to identify in field.

For example, EP 2 878 156 B1 discloses identifying coverage holes in cellular radio communications using measurements associated with handovers between different radio access technologies (i.e., inter-RAT handovers). U.S. Pat. No. 5,465,390 A discloses determining geographic locations of the transmitters and of their technical characteristics in cellular radio communications, so as to achieve optimum compliance with a certain number of constraints, such as geographical coverage. CN 100 473 196 C discloses dynamic spectrum allocation between cellular and broadcast networks. EP 0 556 146 B1 discloses determining and optimizing an overall radio coverage in a planning phase of a cellular radio communications network. In particular, adjacent cells deploy different frequencies. EP 1 964 282 A1 discloses optimizing a joint radiation pattern of a network of adaptive emission antennas. The adaptive emission antennas comprise ground wave emission antennas radiating medium or long waves, switchable polarization ionospheric emission antennas radiating short, medium or long waves toward the ionosphere, and space wave emission antennas radiating short waves toward conurbations.

If areas of bad reception can be identified, it is laborious for network operators to tune the transmission parameters for a better reception. As reception conditions may change dynamically, for example depending on weather conditions or seasonal influences, ongoing manual network optimization is nearly impossible.

Accordingly, there is a need in the art to automatically tune transmission parameters to optimize reception in the SFN.

### SUMMARY OF THE INVENTION

A first aspect of the present disclosure relates to a method for adaptive optimization of reception within a single-frequency network, SFN, comprising at least two independently controlled SFN transmitters. The method comprises:
a) arranging one or more field probes;
b) providing at least one network entity connected to each of the one or more field probes via a network communication channel;
c) the one or more field probes measuring, preferably continuously, an SFN reception of signals transmitted by the at least two independently controlled SFN transmitters, and producing field measurement data;
d) the one or more field probes supplying the field measurement data to the network entity; and
e) the network entity computing optimized SFN transmission parameters based on the supplied field measurement data.

The method further comprises:
f) the network entity automatically calculating, as a function of the supplied field measurement data, at least one type of SFN transmission parameter specifically optimized for each of the at least two independently controlled SFN transmitters, in order to optimize the SFN reception of the signals transmitted by the at least two independently controlled SFN transmitters; and
g) the network entity supplying the transmitter-specifically optimized SFN transmission parameters to each of the at least two independently controlled SFN transmitters.

Preferably, the sequence of steps c) to g) is cyclically repeated for an iterative optimization.

Preferably, the field measurement data supplied to the network entity comprises one or more of or consists of:
signal strength measured by the one or more field probes,
modulation error ratio measured by the one or more field probes, and/or
bit error ratio measured by the one or more field probes.

Preferably, the at least one type of SFN transmission parameter comprises one or more of or consists of:
output power of each of at least two independently controlled SFN transmitters, and/or
static time delay of the signal transmitted by each of the at least two independently controlled SFN transmitters.

A second aspect of the present disclosure relates to a network entity.

The network entity comprises an interface being arranged for receiving field measurement data supplied by one or more field probes arranged in a single-frequency network, SFN, comprising at least two independently controlled SFN transmitters. Each of the one or more field probes is connected to the network entity via a network communication channel.

The network entity further comprises a unit being arranged for computing optimized SFN transmission parameters based on the supplied field measurement data.

The network entity further comprises wherein the unit is arranged for automatically calculating, as a function of the supplied field measurement data, at least one type of SFN transmission parameter specifically optimized for each of the at least two independently controlled SFN transmitters, in order to optimize the SFN reception of the signals transmitted by the at least two independently controlled SFN transmitters.

The network entity further comprises an interface being arranged for supplying the transmitter-specifically optimized SFN transmission parameters to each of the at least two independently controlled SFN transmitters.

Preferably, the network entity is a distributed cloud unit.

A third aspect of the present disclosure relates to a single-frequency network, SFN, system.

The system comprises at least two independently controlled SFN transmitters.

The system further comprises a network entity being arranged for computing optimized SFN transmission parameters specifically for each of the at least two SFN transmitters.

The system further comprises one or more field probes arranged in the SFN and connected to the network entity via a network communication channel. The one or more field probes are arranged for measuring, preferably continuously, an SFN reception of signals transmitted by the at least two independently controlled SFN transmitters, producing field measurement data, and supplying the field measurement data to the network entity.

The system further comprises wherein the network entity is arranged for automatically calculating, as a function of the supplied field measurement data, at least one type of SFN transmission parameter specifically optimized for each of the at least two independently controlled SFN transmitters, in order to optimize the SFN reception of the signals transmitted by the at least two independently controlled SFN transmitters.

The system further comprises wherein the network entity is arranged for supplying the transmitter-specifically optimized SFN transmission parameters to each of the at least two independently controlled SFN transmitters.

Preferably, the network entity is arranged to iteratively optimize the at least one type of SFN transmission parameter. The optimization may be ended when a stop criterion has been met, or may be ongoing throughout the transmission by the SNF transmitters.

Preferably, the field measurement data supplied to the network entity comprises one or more of or consists of:
signal strength measured by the one or more field probes,
modulation error ratio measured by the one or more field probes, and/or
bit error ratio measured by the one or more field probes.

Preferably, the at least one type of SFN transmission parameter comprises one or more of or consists of
output power of each of the at least two independently controlled SFN transmitters, and/or
static time delay of the signal transmitted by each of the at least two independently controlled SFN transmitters.

Preferably, the network entity is one physical entity or a shared entity, such as a cloud entity.

Preferably, the field measurement data are supplied to the network entity using a wireless or a wire-bound channel, using e.g. a telecommunications protocol and/or an Internet protocol.

Preferably, the network entity comprises an Artificial Intelligence unit, such as e.g. a neural network trained with field measurement data and optimized SFN transmission parameters.

Preferably, the network entity is arranged to implement a feedback control in order to optimize the SFN transmission parameters such that the supplied field measurement data converge towards nominal values for the field measurement data. The nominal values are preferably supplied to the network entity beforehand.

Advantageously, measuring the SFN reception of the signals by the one or more field probes results in a reliable coverage monitoring in the field.

Advantageously, measuring the SFN reception of the signals transmitted by the SFN transmitters and in response supplying the SFN transmitters with specifically optimized SFN transmission parameters optimizes the SFN reception without manual efforts, which leads to cost reduction.

Advantageously, this scheme effectively addresses dynamically changing reception conditions, too.

Advantageously, optimizing SFN reception in areas in which bad reception is observed effectively increases a network coverage.

Further advantages, features and object will now become evident when reading the following explanation of embodiments, when taken in conjunction with the figures of the enclosed drawings.

### BRIEF DESCRIPTION OF THE DRAWINGS

The features of these embodiments may be combined with each other unless specified otherwise.

FIG. 1 shows a SFN system according to a third aspect of the present disclosure,

FIG. 2 shows a flowchart of a method according to a first aspect of the present disclosure, and

FIG. 3 shows a network entity according to a second aspect of the present disclosure.

### DETAILED DESCRIPTION OF PREFERRED EMBODIMENTS

These figures are to be regarded as being schematic representations and elements illustrated therein are not necessarily shown to scale. Rather, the various elements are represented such that their function and general purpose become apparent to a person skilled in the art.

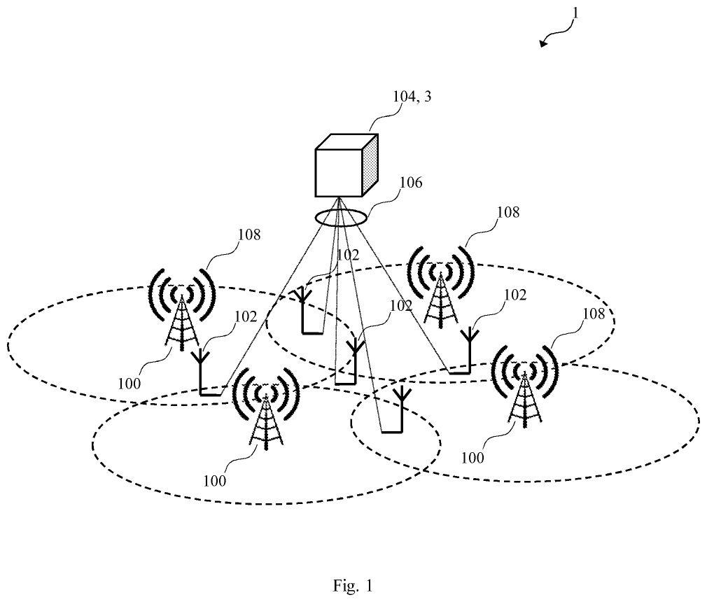

FIG. 1 shows an SFN system 1 according to a third aspect of the present disclosure.

The SFN system 1 comprises at least two independently controlled SFN transmitters 100 being arranged to simultaneously transmit/broadcast a same signal 108 over a same frequency channel. More precisely, FIG. 1 illustrates four independently controlled SFN transmitters 100 having individual coverage areas indicated by dashed circles.

The term “independently controlled” as used herein may refer to “being operable based on transmitter-specific SFN transmission parameters”. For example, SFN transmitters 100 may be operated using different output powers.

The SFN system 1 further comprises one or more field probes 102 arranged in the SFN, in particular at positions within a coverage of the SFN being susceptible to bad reception. In the example of FIG. 1 five field probes 102 are shown arranged at positions where the coverage areas of individual SFN transmitters 100 intersect each other, so that signals 108 of adjacent SFN transmitters 100 might interfere and cancel each other out.

The term “field probe” as used herein may refer to a combination of a radio receiver for measuring analog performance indicators such as a signal strength or modulation error ratio MER, or digital performance indicators such as a bit error ratio BER.

The term “coverage” as used herein may refer to an area in which analog and/or digital performance indicators of a reception exceeds given performance thresholds.

The term “reception” as used herein may refer to a receiver-side operation in which information content is demodulated from a physical communication channel, such as a wireless/radio channel, a wire-bound channel, or a fiber-optic channel.

The term “transmission” as used herein may refer to a transmitter-side operation in which information content is modulated onto a physical communication channel.

The one or more field probes 102 are arranged for measuring, preferably continuously, an SFN reception of signals 108 transmitted by the at least two independently controlled SFN transmitters 100, producing field measurement data, and supplying the field measurement data to the network entity 104, 3.

The SFN system 1 further comprises a network entity 104, 3.

The network entity 104, 3 may be one physical entity or a shared entity, such as a cloud entity. In the example of FIG. 1, a physical entity is depicted.

FIG. 1 schematically indicates by thin dotted lines that the one or more field probes 102 and the network entity 104, 3 are interconnected via a network communication channel 106.

As such, the field measurement data may be supplied to the network entity 104, 3, in particular using a wireless or a wire-bound channel, using e.g. a telecommunications protocol and/or an Internet protocol.

The field measurement data supplied to the network entity 104, 3 may comprise one or more of or consist of: signal strength measured by the one or more field probes 102, modulation error ratio MER measured by the one or more field probes 102, and/or bit error ratio BER measured by the one or more field probes 102.

The network entity 104, 3 is arranged for computing optimized SFN transmission parameters specifically for each of the at least two SFN transmitters 100.

More specifically, the network entity 104, 3 is arranged for computing optimized SFN transmission parameters by automatically calculating, as a function of the supplied field measurement data, at least one type of SFN transmission parameter specifically optimized for each of the at least two independently controlled SFN transmitters 100.

The at least one type of SFN transmission parameter may comprise one or more of or consist of: output power of each of the at least two independently controlled SFN transmitters 100, and/or static time delay of the signal transmitted by each of the at least two independently controlled SFN transmitters 100.

The automatic calculating is carried out in order to optimize the SFN reception of the signals 108 transmitted by the at least two independently controlled SFN transmitters 100.

The term “optimized” as used herein may refer to the circumstance that the optimization improves some given performance metric. In the example at hand, the given performance metric is the (quality/performance of) SFN reception of the signals 108 by the one or more field probes 102.

For the purpose of automatic calculating, the network entity 104, 3 may comprise an Artificial Intelligence unit 304A, such as an artificial neural network trained with field measurement data and optimized SFN transmission parameters serving as examples of known input data and corresponding target result data, respectively. Supervised learning/training of such an artificial neural network involves processing the known input data and determining a difference/error between the processing result and the known target result. According to the error, probability-weighted associations between input and output of the artificial neural network that gave rise to the erroneous processing result are adjusted. Based on iterative adjustments using a plurality of examples, a capacity of the artificial neural network to yield the known target results is successively approached.

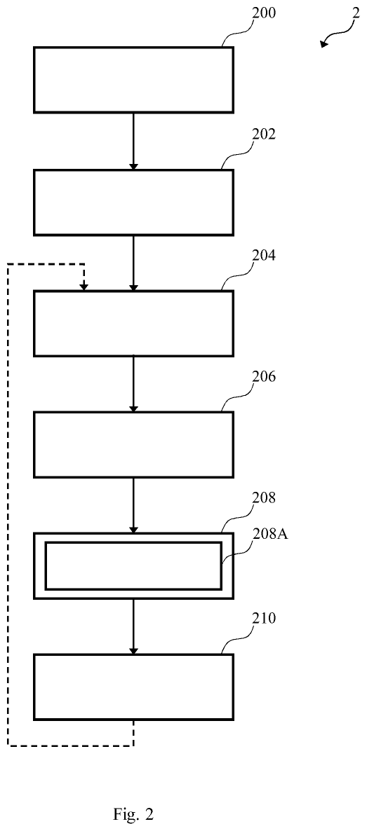

As may become more specific in connection with FIG. 2 below, the network entity 104, 3 may further be arranged to iteratively optimize the at least one type of SFN transmission parameter. In other words, optimization is repeated at least once.

Having calculated the transmitter-specifically optimized SFN transmission parameters, the network entity 104, 3 is further arranged for supplying them to each of the at least two independently controlled SFN transmitters 100.

The network entity 104, 3 may further be arranged to implement a feedback control in order to optimize the SFN transmission parameters such that the supplied field measurement data converge towards nominal values for the field measurement data. In that case, measured/supplied field measurement data may denote the process variable(s), nominal/target field measurement data may serve as the reference variable(s), and a difference between the reference variable(s) and the process variable(s) yields a control error supplied to the controller, i.e., the network entity 104, 3. The network entity 104, 3 automatically calculates SFN transmission parameters representing the manipulated variable(s) supplied to the regulated process, i.e., the radio propagation from the SFN transmitters 100 to the one or more field probes 102.

FIG. 2 shows a flowchart of a method 2 according to a first aspect of the present disclosure.

The method 2 is for adaptive optimization of reception within a single-frequency network, SFN, which comprises at least two independently controlled SFN transmitters 100. The method 2 comprises:
a) a step of arranging 202 one or more field probes 102, in particular at positions within a coverage of the SFN being susceptible to bad reception. This may require manual intervention in the field, such as planning, rolling-out and commissioning the field probes 102.
b) a step of providing 202 at least one network entity 104, 3 connected to each of the one or more field probes 102 via a network communication channel 106. This may require manual intervention either, such as configuration of the at least one network entity 104, 3 and the one or more field probes 102, providing network connectivity and so on.
c) a step of the one or more field probes 102 measuring 204, preferably continuously, an SFN reception of signals 108 transmitted by the at least two independently controlled SFN transmitters 100, and producing field measurement data;
d) a step of the one or more field probes 102 supplying 206 the field measurement data to the network entity 104, 3.

The field measurement data supplied to the network entity 104, 3 may comprise one or more of or consist of: signal strength measured by the one or more field probes 102, modulation error ratio MER measured by the one or more field probes 102, and/or bit error ratio BER measured by the one or more field probes 102.
e) a step of the network entity 104, 3 computing 208 optimized SFN transmission parameters based on the supplied field measurement data.

More specifically, the network entity 104, 3 computes the optimized SFN transmission parameters by:
f) a step of the network entity 104, 3 automatically calculating 208A, as a function of the supplied field measurement data, at least one type of SFN transmission parameter specifically optimized for each of the at least two independently controlled SFN transmitters 100, in order to optimize the SFN reception of the signals 108 transmitted by the at least two independently controlled SFN transmitters 100.

The at least one type of SFN transmission parameter may comprise one or more of or consist of: output power of each of the at least two independently controlled SFN transmitters 100, and/or static time delay of the signal transmitted by each of the at least two independently controlled SFN transmitters 100.

Having calculated the transmitter-specifically optimized SFN transmission parameters, the method (2) further comprises:
g) a step of the network entity 104, 3 supplying 210 the transmitter-specifically optimized SFN transmission parameters to each of the at least two independently controlled SFN transmitters 100.

FIG. 2 further indicates by a dashed arrow connecting steps 210 and 204 that the sequence of steps c) to g) may cyclically be repeated for an iterative optimization.

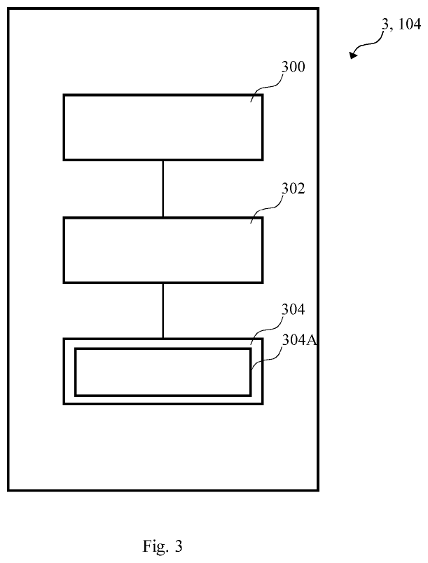

FIG. 3 shows a network entity 3 according to a second aspect of the present disclosure.

The network entity 104, 3 may be a distributed cloud unit.

The network entity 3 comprises an interface 300, a unit 302 and an interface 304.

The interface 300 is arranged for receiving field measurement data supplied by one or more field probes 102 arranged in a single-frequency network, SFN, comprising at least two independently controlled SFN transmitters 100. Each of the one or more field probes 102 is connected to the network entity 104, 3 via a network communication channel 106.

The unit 302 is arranged for computing optimized SFN transmission parameters based on the supplied field measurement data, and more specifically for automatically calculating, as a function of the supplied field measurement data, at least one type of SFN transmission parameter specifically optimized for each of the at least two independently controlled SFN transmitters 100. This is in order to optimize the SFN reception of the signals 108 transmitted by the at least two independently controlled SFN transmitters 100.

The interface 304 is arranged for supplying the transmitter-specifically optimized SFN transmission parameters to each of the at least two independently controlled SFN transmitters 100.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A method for adaptive optimization of reception within a single-frequency network, SFN, comprising at least two independently controlled SFN transmitters, the method comprising the following steps:
a) arranging one or more field probes;
b) providing at least one network entity connected to each of the one or more field probes via a network communication channel;
the one or more field probes
c) measuring, preferably continuously, an SFN reception of signals transmitted by the at least two independently controlled SFN transmitters, and producing field measurement data;
d) supplying the field measurement data to the network entity; and
the network entity
e) computing optimized SFN transmission parameters based on the supplied field measurement data;
characterized by the network entity
f) automatically calculating, as a function of the supplied field measurement data, at least one type of SFN transmission parameter specifically optimized for each of the at least two independently controlled SFN transmitters, in order to optimize the SFN reception of the signals transmitted by the at least two independently controlled SFN transmitters; and
g) supplying the transmitter-specifically optimized SFN transmission parameters to each of the at least two independently controlled SFN transmitters.

2. The method of claim 1,
wherein the sequence of steps c) to g) is cyclically repeated for an iterative optimization.

3. The method of claim 1,
wherein the field measurement data supplied to the network entity comprises one or more of or consists of:
signal strength measured by the one or more field probes,
modulation error ratio (MER) measured by the one or more field probes, and/or
bit error ratio (BER) measured by the one or more field probes.

4. The method of claim 1,
wherein the at least one type of SFN transmission parameter comprises one or more of or consists of:
output power of each of at least two independently controlled SFN transmitters, and/or
static time delay of the signal transmitted by each of the at least two independently controlled SFN transmitters.

5. A network entity, having:
an interface being arranged for receiving field measurement data supplied by one or more field probes arranged in a single-frequency network, SFN, comprising at least two independently controlled SFN transmitters, each of the one or more field probes being connected to the network entity via a network communication channel,
a unit being arranged for computing optimized SFN transmission parameters based on the supplied field measurement data,
characterized by
the unit being arranged for automatically calculating, as a function of the supplied field measurement data, at least one type of SFN transmission parameter specifically optimized for each of the at least two independently controlled SFN transmitters, in order to optimize the SFN reception of the signals transmitted by the at least two independently controlled SFN transmitters, and
an interface being arranged for supplying the transmitter-specifically optimized SFN transmission parameters to each of the at least two independently controlled SFN transmitters.

6. The network entity of claim 5,
wherein the network entity is a distributed cloud unit.

7. A single-frequency network, SFN, system comprising:
at least two independently controlled SFN transmitters;
a network entity being arranged for computing optimized SFN transmission parameters specifically for each of the at least two SFN transmitters; and
one or more field probes arranged in the SFN and connected to the network entity via a network communication channel, being arranged for measuring, preferably continuously, an SFN reception of signals transmitted by the at least two independently controlled SFN transmitters, producing field measurement data, and supplying the field measurement data to the network entity;
characterized by the network entity being arranged for
automatically calculating, as a function of the supplied field measurement data, at least one type of SFN transmission parameter specifically optimized for each of the at least two independently controlled SFN transmitters, in order to optimize the SFN reception of the signals transmitted by the at least two independently controlled SFN transmitters, and
supplying the transmitter-specifically optimized SFN transmission parameters to each of the at least two independently controlled SFN transmitters.

8. The system of claim 7, wherein
the network entity is arranged to iteratively optimize the at least one type of SFN transmission parameter.

9. The system of claim 7,
wherein the field measurement data supplied to the network entity comprises one or more of or consists of:
signal strength measured by the one or more field probes,
modulation error ratio (MER) measured by the one or more field probes, and/or
bit error ratio (BER) measured by the one or more field probes.

10. The system of claim 7,
wherein the at least one type of SFN transmission parameter comprises one or more of or consists of
output power of each of the at least two independently controlled SFN transmitters, and/or
static time delay of the signal transmitted by each of the at least two independently controlled SFN transmitters.

11. The system according to claim 7,
wherein the network entity is one physical entity or a shared entity, such as a cloud entity.

12. The system according to claim 7,
wherein the field measurement data are supplied to the network entity using a wireless or a wire-bound channel, using e.g. a telecommunications protocol and/or an Internet protocol.

13. The system according to claim 7,
wherein the network entity comprises an Artificial Intelligence unit, such as e.g. a neural network trained with field measurement data and optimized SFN transmission parameters.

14. The system according to claim 7,
wherein the network entity is arranged to implement a feedback control in order to optimize the SFN transmission parameters such that the supplied field measurement data converge towards nominal values for the field measurement data.
